(19) United States
(12) Patent Application Publication
(10) Pub. No.: US 2022/0162529 A1
(43) Pub. Date: May 26, 2022

(54) PACKAGING AND PRODUCTS MADE USING SPENT GRAINS

(71) Applicant: COORS BREWING COMPANY, Milwaukee, WI (US)

(72) Inventors: Darin MCKNIGHT, Pewaukee, WI (US); Jason KELLY, Arvada, CO (US); Bruce SMITH, Mississauga, Ontario (CA); Ray A. TOMS, Golden, CO (US)

(21) Appl. No.: 17/442,087

(22) PCT Filed: Apr. 10, 2020
(86) PCT No.: PCT/US2020/027749

§ 371 Date: Sep. 22, 2021

Related U.S. Application Data
(60) Provisional application No. 62/836,411, filed on Apr. 19, 2019.

(51) Int. Cl. C12F 3/06; B07B 1/46; D21B 1/06; D21J 3/00

(52) U.S. Cl. CPC C12F 3/06; B07B 1/4609; B07B 2230/01; D21J 3/00; D21B 1/06

(57) ABSTRACT

Methods and systems are provided for processing constituent materials from brewer's spent grains (BSG) for making packaging and/or products. The spent grains are arranged into a set of balanced constituent materials of approximately 80% to 90% grains, 10% to 20% hops, and less than 1% of spices by weight. This set of constituent materials is then formed into products, such as paper and packaging. The paper can be used to create labels or other carriers for beverages, especially for bottled beverages.

### CROSS REFERENCE TO RELATED APPLICATION

The present application claims the benefit of and priority, under 35 U.S.C. § 119(e), to U.S. Provisional Application Ser. No. 62/836,411, filed Apr. 19, 2019, entitled “Packaging and Products Made Using Spent Grains,” the entire disclosure of which is hereby incorporated herein by reference, in its entirety, for all that it teaches and for all purposes.

### FIELD

The present disclosure is generally directed to packaging and product materials, in particular, toward methods and systems for making packaging and products using spent grains.

### BACKGROUND

Brewer's spent grain (BSG) is a major by-product of the brewing industry, representing about 85% of the total by-products generated. Although BSG is rich in fiber and protein, its main use has been as animal feed. There has been interest in expanding the use of B SG, but there has not been a solution that can feasibly be scaled to volume. Every ton of BSG processed produces a ton of BSG. Since centralized municipal composts are unavailable in the vast majority of cities, and distribution of BSG to farms is costly and time-sensitive, urban brewers typically have no choice but to relegate their BSG to a landfill.

In some industries, ethical concerns may prevent BSG from being used without conditions. For instance, vegan breweries choose to send their BSG to the landfill because they do not support sending their BSG to the animal farming industry. Alternatively, it is common for a brewery to produce more BSG than local farms can consume. In this situation, the BSG may also end up in a landfill.

### BRIEF DESCRIPTION OF THE DRAWINGS

FIG. 1 is a block diagram of a system for harvesting protein and fiber rich flour from BSG in accordance with embodiments of the present disclosure;

FIG. 2 is a block diagram of a cell mill in accordance with embodiments of the present disclosure;

FIG. 3 is a flow diagram of a method for harvesting protein and fiber rich flour from BSG in accordance with embodiments of the present disclosure;

FIG. 4 is a graphical representation of the effects of storing BSG at a heated temperature to control and limit bacterial growth in accordance with embodiments of the present disclosure;

FIG. 5 is a chart of protein and fiber yield percentages from fractionated BSG in accordance with embodiments of the present disclosure;

FIG. 6 is a table of nutritional information associated with protein rich product extracted from BSG in accordance with embodiments of the present disclosure;

FIG. 7. is a table of nutritional information associated with fiber rich product extracted from BSG in accordance with embodiments of the present disclosure;

FIG. 8 is a block diagram of a system for processing constituent materials from BSG for making packaging and/or products in accordance with embodiments of the present disclosure; and

FIG. 9 is a flow diagram of a method for processing constituent materials from BSG for making packaging and/or products in accordance with embodiments of the present disclosure.

### DETAILED DESCRIPTION

It is with respect to the above issues and other problems that the embodiments presented herein were contemplated. Embodiments of the present disclosure may be described in connection with a spent grain protein and fiber extraction system. In general, embodiments of the present disclosure provide methods, devices, and systems for processing constituent materials from spent grains, such as brewer's spent grains (BSG), for making sustainable eco-friendly packaging and/or products therefrom. In some embodiments, the methods and systems disclosed herein may process the BSG as part of an extraction process where protein rich and fiber rich flour, or product, is extracted from spent grains. The methods and systems described herein may be part of an all-dry process (e.g., a process that does not require chemical treatment, rinsing, and/or high water usage, etc.). It is an aspect of the present disclosure to use BSG, or other BSG waste, for making environmentally-friendly materials for packaging and/or other products.

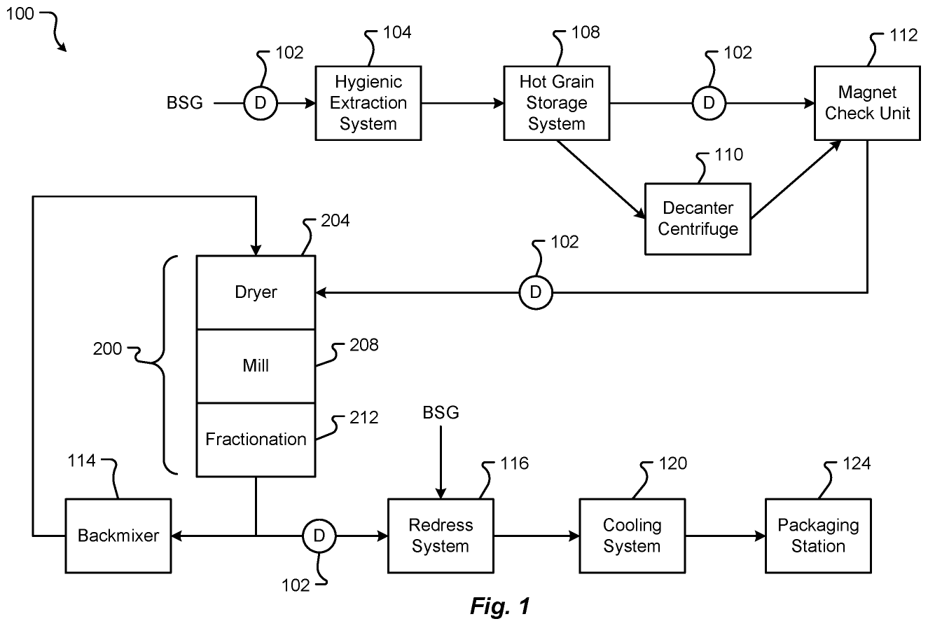

FIG. 1 shows a block diagram of a spent grains protein and fiber product extraction system 100 in accordance with embodiments of the present disclosure. The extraction system 100 may include a hygienic extraction device or system 104, a hot grain storage system 108, a decanter centrifuge 110, a magnet check device or unit 112, a cell mill system 200, a backmixer 114, a magnet redress system 116, a cooling system 120, and a packaging station 124 and/or facility that packages the finished product for storage and/or transport.

In some embodiments, the BSG and/or one or more constituent materials (e.g., ingredients for making packaging, products, etc.) from may be diverted from the fiber product extraction system 100 or other area of a brewing facility via a pipe, conduit, belt, elevator, conveyor or other type of material handling device 102. The BSG and/or the one or more constituent materials may be diverted at one of the device 102 points (e.g., labeled “D”) at more than one of the device 102 points, and/or at each of the device 102 points. The constituent materials may comprise a mixture of grains, hops, and spices in the BSG. In one embodiment, the mixture may comprise 80% to 90% grains, 10% to 20% hops, and a trace amount (e.g., less than 1%) of spices by weight. In yet another embodiment, the mixture may comprise approximately 84.6% malt and wheat (e.g., grains), 14.9% hops, and 0.5% spice and flavoring. In some embodiments, the mixture may comprise, within plus or minus 5%, approximately 85% grains, 15% hops, and a trace amounts of spices by weight. It should be appreciated that proportions of the mixture may be selected from any number in the ranges provided herein.

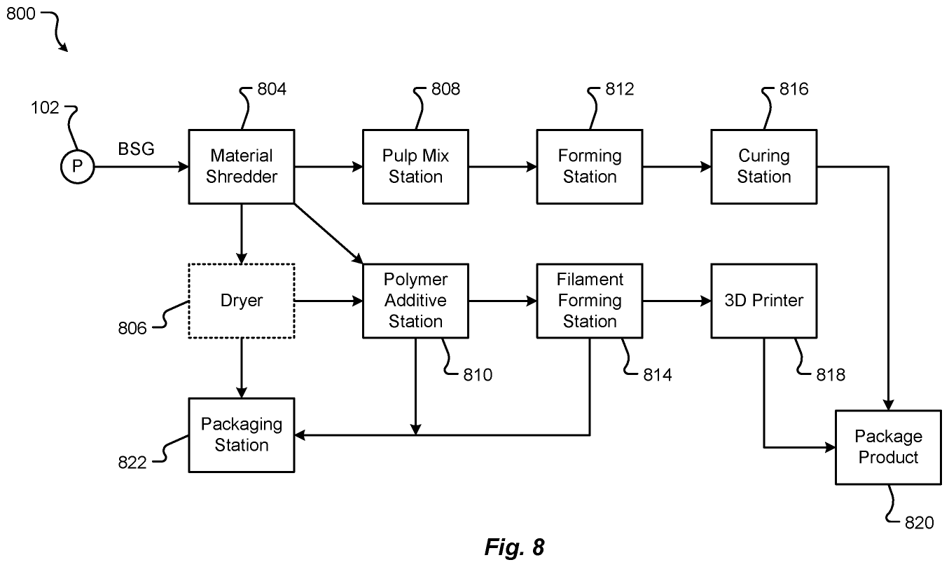

As shown in FIG. 1, the BSG and/or constituent materials may be diverted by the material handling device 102 at any point, D, in a facility where BSG is present, handled, processed, and/or refined. For example, the BSG may be diverted from a point in the brewing process (e.g., from brewing equipment, after mashing, etc.), from storage containers, tanks, and systems, from a fractionation system (e.g., prior to, or after, fractionation, etc.), and/or other points where at least a portion of available, refined, and/or fractionated BSG can be found. Further details for processing the constituent materials (e.g., for making packaging and/or products) from BSG may be described in conjunction with FIG. 8.

The BSG may enter the extraction system 100 via a hygienic extraction system 104. Conventional spent grains, or BSG, may be stored in standard containers, such as pails, canisters, skips, or other receptacles. These standard containers may include exposed volumes, uncoated surfaces, non-food grade plastics, and/or unhygienic surfaces and/or materials. The extraction system 100 may require food grade interfaces, transfer equipment, augers, storage containers, and the like. In one embodiment, the hygienic extraction system 104 may include one or more pumps or augers configured to transfer BSG from a brewer's controlled equipment to the hot grain storage system 108.

The hot grain storage system 108 may comprise a silo and a heating device configured to store and regulate the temperature of the BSG. In one embodiment, the hot grain storage system 108 may include a temperature sensing unit and/or temperature controller configured to efficiently manage the temperature control process of the BSG. The hot grain storage system 108 may include an aeration fan to provide steady air flow through the BSG. In some embodiments, BSG in the system 108 may be heated, or otherwise temperature controlled, at a predetermined temperature using positive pressure aeration systems, working together with the aeration fan to move a warming zone through the BSG. Multiple cycles may be applied depending on the time needed for a warming zone to completely move through the stored BSG mass.

In some embodiments, the received BSG may need to be dewatered to reduce its moisture content for processing in the extraction system 100. For example, in the event that BSG was received from a lauter tun in the brewing process, the moisture content of the BSG may be determined to be above a threshold value. Continuing this example, the BSG may be determined to be between approximately 20% to 27% dry. While the BSG may be dried to over 30% dry with a mash filter, BSG from a lauter tun may be dewatered to 30% to 39% or more dry using a dewatering device, such as a decanter centrifuge 110. In some embodiments, the decanter centrifuge 110 may include a feed tube, an adjustable ring, a gear box, a solids discharge chamber, a liquids discharge chamber, an exterior bowl, a scroll conveyor, a motor, a reduction gear, a main bearing, and/or a separator vane stack. The decanter centrifuge 110 may use continuous rotation to increase the rate of settling whereby the BSG, having a higher density than water, falls to the bottom of a mixture, while the water is suspended above it. Once the BSG is determined to have an acceptable moisture content (e.g., at or below predetermined threshold value, etc.) the BSG may be directed to a magnet check unit 112.

The magnet check unit 112 may be configured to remove, collect, and/or clear foreign material from the BSG. For example, the magnet check unit 112 may remove ferrous material, magnetic material, and/or other objects from the BSG. In some embodiments, the magnet check unit 112 may have a drum with magnets arranged in alternating poles, a metal discharge chamber and a non-metal discharge chamber. Constructed with a 180-degree stationary magnet system on which a cover revolves, material may be fed onto the drum cover at the leading point of the magnet section, causing magnetic materials to adhere to the drum as it revolves, and subsequently be discharged into the metal discharge chamber as it travels outside of the magnetic trajectory. Non-metal material will free fall forward into the non-metal discharge chamber following their normal trajectory.

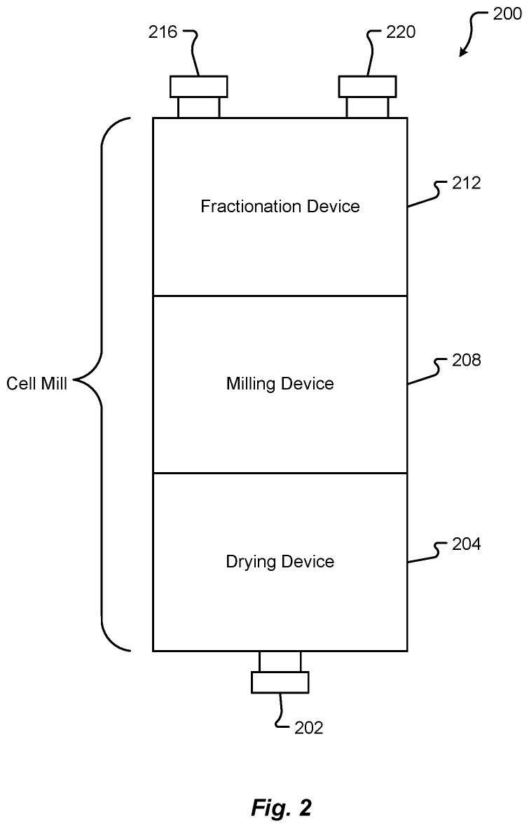

Next, the BSG may be separated into protein rich product and fiber rich product via a cell mill 200. The cell mill 200 may comprise one or more devices or systems configured to dry, mill, and/or fractionate the BSG into protein and/or fiber rich product. The cell mill 200 is described in greater detail in conjunction with FIG. 2 below.

In some embodiments, the cell mill 200 may produce a coarse fiber rich material which can be refed into the cell mill 200 for subsequent processing. This process of re-milling coarse material via the cell mill 200 may be known as back mixing. In one embodiment, a backmixer 114 may be used to convey processed coarse fiber rich material from an outlet of the cell mill 200 back into an inlet of the cell mill 200 for further refinement. This process may be repeated until all of the coarse material is processed into fine protein rich product.

Once extracted, the protein rich product and the fiber rich product may be directed into a redressing system 116 to remove, collect, and/or clear foreign material from each of the respective products. In some embodiments, previously dried and/or prepared BSG may be provided to the redressing system 116 without requiring some, or any, of the processing described in conjunction with the hygienic extraction system 104, hot grain storage system 108, decanter centrifuge 110, magnet check device or unit 112, or the cell mill system 200. The foreign material may be introduced by the cell mill, transfer equipment, exposure, and/or other interruptions in the system 100. In some embodiments, the redressing system 116 may include a crude screen to remove large objects from the products and a magnet to remove ferrous material, magnetic material, and/or other metal objects from the products. In one embodiment, the magnet may be similar, if not identical, to the magnet check unit 112 described above.

The extraction system 100 may employ a cooling system 120 to cool the protein rich and fiber rich product prior to packaging. The cooling system 120 may include a refrigeration unit and one or more chambers, through which, the protein rich and fiber rich product passes to cool. In one embodiment, the cooling system 120 may employ one or more fans, accumulation conveyors, and/or cooling techniques to reduce the temperature of the products prior to packaging. In some embodiments, the cooling system 120 may comprise a cooling unit and a storage compartment to allow the extracted product to be stored at a regulated, cool temperature prior to packaging. Product fed into the cooling station 120 may require cooling to below 30 degrees Celsius.

The extracted product may be diverted into separate areas or along separate paths for packaging at the packaging station 124. For instance, the protein rich product (e.g., flour) may be directed to a protein product packaging area, while the fiber rich product may be directed to a different fiber product packaging area in the packaging station 124. In any event, the packaging station 124 may be configured to package the protein and/or fiber extract into shipping, storage, transport, or other containers. In one embodiment, the containers may be configured as boxes, bags, 25-kilogram sacks, 1-ton bags, or 20-ton bulk loads. In some embodiments, the protein and fiber extract may be packaged in one or more of the containers and stored until ready to be distributed.

FIG. 2 is a block diagram of a cell mill 200 in accordance with embodiments of the present disclosure. In one embodiment, the cell mill 200 may be a modified version of the model CM1500 cell mill manufactured by Atritor, or equivalent combination milling system, which may contain a drying device, a milling device, and a fractionation device in a single machine. The cell mill 200 may include an infeed 202, or inlet, and one or more outlets 216, 220. The infeed 202 may receive the BSG for processing, a first outlet 216 of the cell mill 200 may outfeed the fiber rich product, or coarse material, and the second outlet 220 of the cell mill 200 may outfeed the protein rich product, or fine material. The constituent ingredients used to make packaging and/or products from the BSG may comprise one or more of the coarse material, the fine material, and/or waste material from the cell mill 200.

In one embodiment, the BSG may enter the cell mill 200 via a drying device 204. The drying device 204 may include an indirect gas fired system that filters fresh air as it is drawn into the cell mill 200 to remove any particles or insects that could end up in the product. In some embodiments, the drying device 204 may produce heat at a temperature of up to 450 degrees Celsius or more. In some embodiments, the drying device 204 may be operated at a temperature between 300-350 degrees Celsius.

The milling device 208 may include a number of rotating blades arranged on a shaft configured to grind the BSG into a coarse and fine material. The coarse material may be associated with a fiber rich product and the fine material may be associated with a protein rich product, or flour. In some embodiments, the milling device 208 may include a frequency inverter, or other controller, to regulate the speed of the milling device 208. The speed of the milling device 208 may be selected and/or adjusted to produce the desired particle size of the flour and/or the fiber extract. Higher milling speeds tend to mill more material into fine particles and generate a higher concentration of protein rich flour. In some embodiments, the cell mill 200 may feed material (e.g., BSG, spent grains, etc.) into the base of the machine with drying and milling operations taking place simultaneously. In one embodiment, the classification described herein may be performed at the top of the cell mill 200.

The fractionation device 212 may include a classifier rotor, a fiber extract discharge vent (e.g., the first outlet 216) and at least one protein flour discharge vent (e.g., the second outlet 220). Fractionation may be achieved via classification on the basis of material or particle size of the extracted product. Running the classifier at slower speeds allows larger particles (e.g., fiber extract, etc.) to pass through, which reduces the protein percentage of the finished product. Running the classifier at faster speeds will allow finer particles to pass and increase the purity, or protein percentage, of the finished product. The classifier may be used to separate fiber and protein extract from the processed BSG into different product discharge vents (e.g., first outlet 216 and second outlet 220).

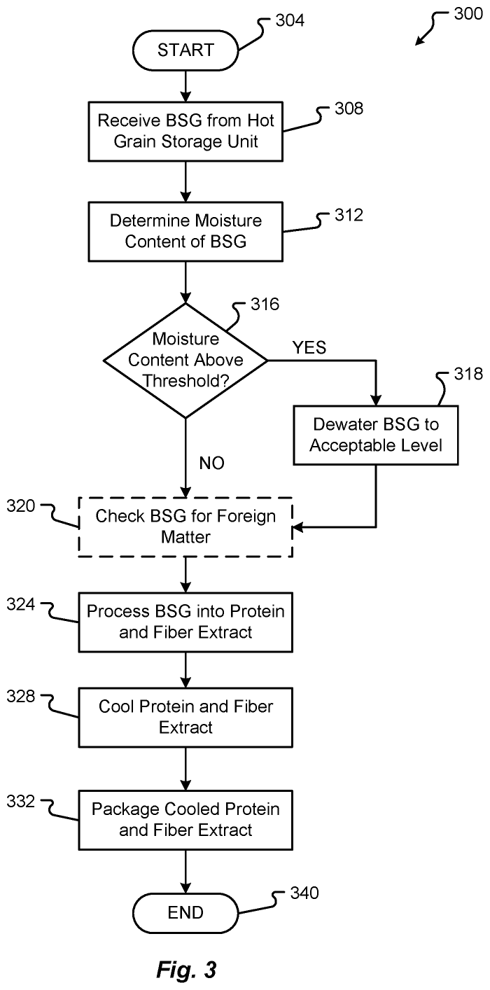

FIG. 3 is a flow diagram of a method 300 for harvesting protein rich and fiber rich product, such as flour, from BSG. While a general order of the steps is shown, the method 300 can include more or fewer steps or can arrange the order of the steps differently than those shown in FIG. 3. In some embodiments, the method 300 may be performed in full, or in part, by a controller comprising a processor and a memory. For example, the controller may be a programmable logic controller (PLC) configured to perform any of the steps of the method 300 automatically and/or in one or more sequences. In one embodiment, the steps of the method 300 may be performed by a number of processors or controllers, associated with one or more of the subsystems, devices, units, and/or systems in the extraction system 100.

The method 300 may begin at step 304 and proceed by receiving BSG from a hot grain storage unit 108 (step 308). The BSG may comprise spent grains from a brewer hygienically controlled and stored. In one embodiment, the BSG may be stored in the hot grain storage system 108 as described in conjunction with FIG. 1. As provided above, the hot grain storage system 108 may be configured to maintain the BSG at a control temperature (e.g., at approximately 76 degrees Celsius, etc.). The control temperature may be selected to control, limit, or eliminate bacterial growth in the stored BSG. In some embodiments, the BSG may be heated to maintain the temperatures of the BSG using at least one heating element and temperature sensor or thermocouple. The temperature sensor may be configured to detect a temperature of the BSG in the hot grain storage system 108 and provide the temperature information to a temperature controller. In this case, the temperature controller may be configured to selectively control the at least one heating element (e.g., providing a power signal activating the heating element when a low temperature, or temperature under the control temperature, is detected and removing the power signal deactivating the heating element when a high temperature, or temperature over the control temperature, is detected, etc.).

In some embodiments, the method 300 may continue by determining the moisture content, or dryness, of the BSG received from the hot grain storage unit 108 (step 312). Moisture content may be measured using one or more moisture sensors in the extraction system 100. The moisture sensors may measure moisture in the BSG via measuring electrical resistance of the BSG, dielectric constant of the BSG, or some other physical contact with the BSG. In one embodiment, the BSG may be measured for moisture by testing a sample of the BSG using gravimetric analysis. Additionally or alternatively, the moisture content of BSG may be estimated based on the source of the BSG in the brewing process. For example, BSG originating from a lauter tun may be determined to have a higher moisture, or water, content than BSG originating from a mash filter.

In any event, the BSG may be analyzed to determine whether the moisture content is within acceptable levels (e.g., at or below a threshold value, etc.) for further processing in the extraction system 100 (step 316). In one embodiment, the threshold value moisture content for the BSG may be set at approximately 30% dry. If the moisture content is determined to be above the threshold value, the method 300 may continue by dewatering the BSG to a level at or below 70% wet (e.g., greater than approximately 30% dry). The BSG may be dewatered using a decanter centrifuge 110, a dehumidifier, a press, a forced air dryer, and/or some other drying mechanism or system. Among other things, drying the BSG to acceptable levels increases the efficiency of the extraction system 100. For instance, once product enters the cell mill 200, the drying device may operate at lower speeds, lower energy levels, and/or lower air flows to dry the BSG for milling and fractionation. In any event, once sufficiently dry, the BSG may be conveyed to a foreign matter check and removal system (step 320). The foreign matter check and removal system may be similar, if not identical, to the magnet check unit 112 described in conjunction with FIG. 1. In some cases, the BSG may be checked for foreign matter using a metal drum, screen, and/or mechanical separator.

Next, the method 300 may continue by processing the BSG into protein rich and fiber rich products (step 324). In one embodiment, the BSG may be processed into protein and fiber extract using a combination of drying, milling, and fractionation. In some embodiments, the process of drying, milling, and fractionation may be performed by a single machine, such as the cell mill 200 described in conjunction with FIG. 2 above. In some embodiments, the cell mill 200 may feed material (e.g., BSG, spent grains, etc.) into the base of the machine with drying and milling operations taking place simultaneously. However, it should be appreciated that one or more of the drying, milling, and fractionation may be performed by a number of different machines and/or systems. The cell mill 200 may use an indirect gas fired system to dry the BSG for optimized protein and fiber extraction. For instance, fresh air may be drawn into the system (filtered to remove any particles/insects, etc.) that could end up in the extracted protein and/or fiber product. In some embodiments, increasing the temperatures used in the dryer 204 of the cell mill may increase the overall capacity (e.g., the capability of the dryer to accommodate more BSG, etc.) of the dryer 204. In some cases, the heat generated by the dryer 204 may be recovered to further increase the efficiency of the cell mill 200.

In processing the BSG (step 324), the cell mill 200 may use a series of rotating blades to extract protein rich product (e.g., fine product, or flour) and fiber rich product (e.g., coarse product) from BSG. The speed and residence time can be manipulated to control the particle size produced by the cell mill 200. Protein particles tend to be softer and mill finer than fiber rich particles. The milling of an abrasive product like BSG may cause mechanical wear of the various components of the cell mill 200 including the rotating blades of the milling device 208. In some cases, for example, where metal rotating blades are used, a redress system 116 may be employed to separate metal particulate and/or other debris from the extracted products (e.g., the protein rich product and the fiber rich product). In some embodiments, the rotating blades may be hardened, coated (e.g., with a ceramic coating, or other hard coating, etc.), and/or manufactured from sufficiently hard material providing increased resistance to wear. As provided above, the mill speed may be optimized to obtain a desired product particle size.

Once the product is milled by the milling device 208, the processing (step 324) of the product may continue by classifying the product based on size. In some embodiments, the cell mill 200 may include a classifier that is configured to separate coarse fiber rich product from fine protein rich product. The classifier may comprise one or more screens, rotating bars, and/or sieves configured to separate the product. In some embodiments, the classifier speed can be altered to change the cut point between product and oversize material. Running the classifier slower may allow larger particles to pass through and reduce the purity of the finished product, while running the classifier faster may allow finer particles to pass through and increase the purity of the finished product. Oversize product (i.e., fiber rich product) may be collected in a silo and used for animal feed. Additionally or alternatively, the oversize product may be re-milled (e.g., or back mixed in the cell mill 200) into a fine powder and sold as a food grade fiber. In one embodiment, the classification described herein may be performed at the top of the cell mill 200, as shown in the schematic diagram of FIG. 2.

The method 300 may continue by cooling the extracted protein rich product and/or fiber rich product prior to packaging (step 328). As described above and in conjunction with FIG. 1, the extracted product may be passed through a cooling system 120 to prepare the product for packaging. The cooling system 120 may include a refrigeration unit and one or more chambers, through which, the protein rich and fiber rich product passes to cool. Cooling may include lowering the temperature of the protein rich flour to a temperature below 30 degrees Celsius. In some cases, the product may be stored in temperature controlled or refrigerated silos/containers prior to packaging. Once the product is processed by the cell mill (step 324), the product is stable for storage at a standard range of ambient temperatures, especially 72 degrees Fahrenheit. The product is stable in that the protein rich flour and/or fiber rich flour is sufficiently dry and processed providing an environment resistant to the unprocessed and uncontrolled BSG bacterial growth. The protein rich flour and/or fiber rich flour may be packaged similarly, if not identically, to the method described in conjunction with the packaging station 124 of FIG. 1 (step 332). The method 300 may end at step 340.

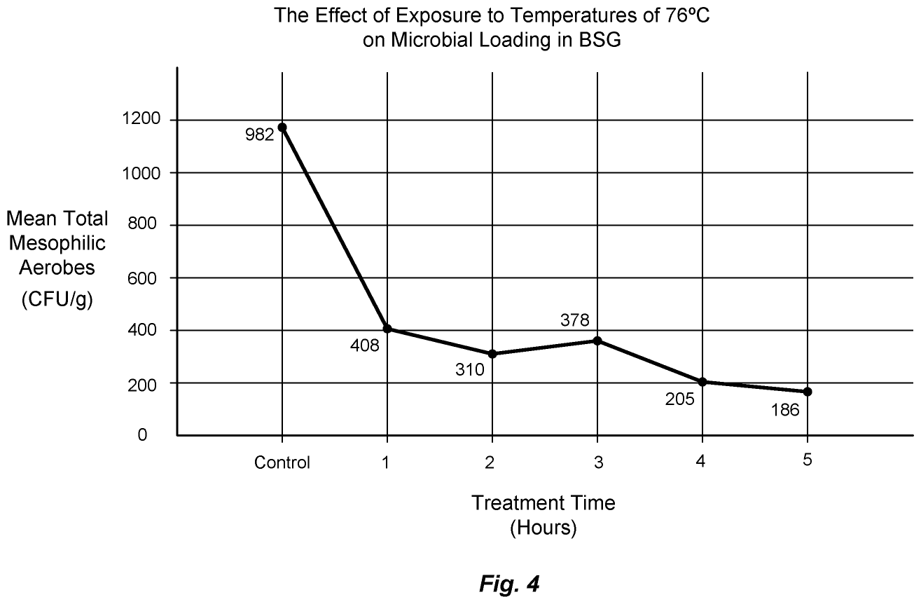

FIG. 4 is a is a graphical representation of the effects of storing BSG at a heated temperature to control and limit bacterial growth in accordance with embodiments of the present disclosure. For example, storing the BSG at a temperature of approximately 76 degrees Celsius may reduce the mean total mesophilic aerobes from 982 CFU/g to 186 CFU/g in approximately five hours of treatment time. As described above, the hot grain storage system 108 may be configured to provide this heated temperature control.

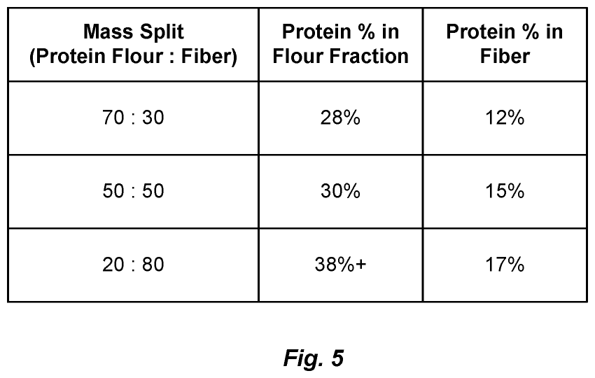

FIG. 5 is a chart of protein and fiber yield percentages from fractionated BSG in accordance with embodiments of the present disclosure. As illustrated in FIG. 5, splitting the mass of the extracted flour into 70 percent protein flour mass and 30 percent fiber mass produces 28 percent protein in the flour fraction (i.e., the protein rich product) and 12 percent protein in the fiber (e.g., the fiber rich product). A split of 50 percent protein flour mass and 50 percent fiber mass produces 30 percent protein in the protein rich product flour fraction and 15 percent protein in fiber rich product fraction. A split of 20 percent protein flour mass and 80 percent fiber mass yields at least 38 percent protein in the protein rich product flour fraction and 17 percent in fiber rich product fraction. These three different levels represent examples of various levels of purity and yield that can be selected and/or set (e.g., varying rotation speeds of the cell mill, etc.) using the methods 300 and systems 100 described herein.

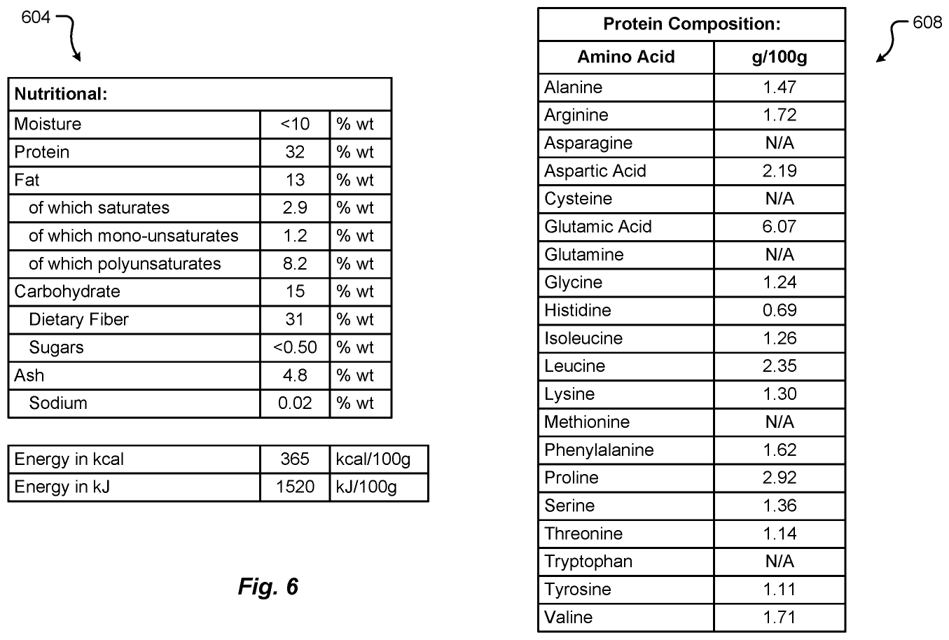

FIG. 6 is a table of nutritional information associated with protein rich product extracted from BSG in accordance with embodiments of the present disclosure. The table includes nutritional information by percentage weight 604 and the composition 608 of the protein rich product in one example fractionation percentage. As shown in FIG. 6, the protein percentage by weight of the protein rich product is approximately 32% in an example percentage mass split.

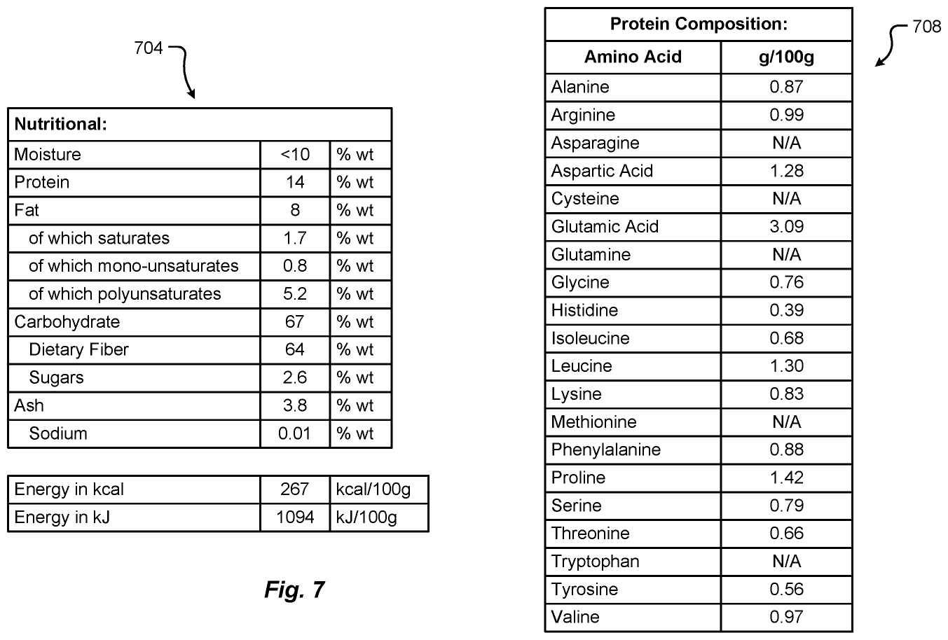

FIG. 7. is a table of nutritional information associated with fiber rich product extracted from BSG in accordance with embodiments of the present disclosure. The table includes nutritional information by percentage weight 704 and the composition 708 of the fiber rich product in one example fractionation percentage. As shown in FIG. 7, the protein percentage by weight of the fiber rich product is approximately 14% in an example percentage mass split.

FIG. 8 is a block diagram of a system 800 for processing constituent materials from BSG for making packaging and/or products in accordance with embodiments of the present disclosure. In some embodiments, the system 800 may receive BSG obtained from a brewing process. The BSG may be received in part, or whole, from multiple sources or a single source, respectively. Stated another way, a portion of the BSG (e.g., the grain husks, sprouts, etc.) may be received separately from multiple sources and combined in the appropriate proportions to form the BSG for producing packaging and/or products as described herein. In some embodiments, the BSG, or a portion thereof, may comprise wet, or undried, spent grains. In some cases, wet BSG may be required to be dried prior to preparing for packaging and product manufacture. For instance, it may be difficult to determine and control an amount of water in the BSG without first drying the product using a controlled process. In one embodiment, the BSG, or a portion thereof, may be provided in the form of dry, or previously dried, spent grain husks and sprouts. For example, in a brewing process, the malt may be provided to a brewery, while any rootlets and grain chaff may be provided for package and/or product manufacturing. In any event, the BSG may include 80% to 90% grains, 10% to 20% hops, and less than approximately 1% of spices by weight.

The system 800 may include a material shredder 804, a dryer 806, a pulp mix station 808, a polymer additive station 810, a forming station 812, a filament forming station 814, a curing station 816, a three-dimensional (3D) printer 818, and/or a packaging station 822. In some embodiments, the various components of the BSG processing system 800 may work together in manufacturing a product 820 such as paper, packaging, or the like. The BSG and/or the constituent materials may be conveyed along one or more pipes, chutes, or conveyors connecting one component of the system 800 with another component of the system 800 shown in FIG. 8.

The material shredder 804 may include a number of cutting and/or tearing elements (e.g., blades, gears, mechanical fingers, etc.) arranged to separate the BSG into predetermined sizes of constituent materials (e.g., a predetermined shred size). The predetermined shred size may include a fiber length,

The pulp mix station 808 may comprise a holding tank, or other container, for the shredded constituent materials to be mixed with a predetermined amount of water and/or other ingredients such as chemicals. In some embodiments, the chemicals may comprise at least one of a binding agent and a bleach or dye. In one embodiment, the chemicals may be added to the shredded constituent materials to inhibit bacterial growth. In some embodiments, the composition of the constituent materials in the pulp mix station 808 may be selectively adjusted to suit a particular type of product to be made. For instance, shorter fibers in the BSG may, in some cases, produce a weaker paper product than a product manufactured with longer fibers and, as such, the shorter fiber mix can be used to manufacture fine paper, box dividers, and/or non-structural products/packaging. In some embodiments, shorter fibers utilized at the pulp mix station 808 may require a change to a size of the screens used in the forming station 812, etc. (e.g., finer screens for shorter fibers, etc.).

The forming station 812 may comprise a number of forming elements configured to receive and hold at least a portion of the pulp mix exiting the pulp mix station 808. In one embodiment, the forming station 812 may comprise one or more mesh screens. The pulp mix may be sprayed, or otherwise deposited, onto a mesh screen until a layer of the processed BSG mixture is formed. The mesh screen may be configured allow a predetermined size of fiber (e.g., short fibers, etc.), water, and/or chemicals to pass through, while a specific fiber size (e.g., greater than the predetermined size of fiber) is retained on the mesh screen. In this example, the material sprayed, or otherwise deposited, onto the mesh screens may be used to manufacture paper products, labels, boxes, cardboard products, or rolls of paper and/or cardboard that can be later converted into one or more other products. In some embodiments, the material may be formed into a flattened sheet of material (e.g., pressed between two rollers, compressed between plates, and/or otherwise pressed, etc.). In this instance, the flattened sheet of material (e.g., paper, etc.) may be wound in a roll onto a core (e.g., a cylindrical core, etc.). The roll of material may be used in a converting machine to form boxes, carriers, or other cardboard-like structures. In another embodiment, the forming station 812 may comprise at least one mold (e.g., injection mold, rotational mold, etc.) into which the processed BSG mixture may be introduced. The processed BSG mixture may be injected, poured, or otherwise directed into the mold and then formed or pressed into one or more product/package shapes (e.g., a flat, 3D, or other shape, and/or combinations thereof). In this example, the processed BSG mixture be used to manufacture molded and shaped products such as beverage carriers, beverage carrier rings, coasters, boxes, etc.

The curing station 816 may comprise a heated, ultraviolet (UV), and/or time-cure system that allows the processed BSG mixture to dry and cure into the product/package produced in the forming station 812. In some embodiments, the curing station 816 may comprise a portion of the forming station 812. For instance, one or more parts of the forming station 812 may be heated or dried to cure the formed processed BSG mixture. In one embodiment, the curing station 816 may include a decorative treatment for the formed processed BSG mixture. For example, the decorative treatment may include a metallization station that applies a metallic element to at least one side of the formed processed BSG mixture. In the case of manufacturing labels for beverage bottles using the process described herein, an outward facing side of the label may be metalized by, for example, vacuum depositing a metallic layer onto the surface of the outward facing side.

In some embodiments, the dryer 806 may comprise a forced air dryer, centrifuge, heater, dehumidifier, or other system that dries, and/or otherwise removes water content from, the shredded constituent materials. In particular, wet BSG (e.g., BSG having a specific water content) may be dried in preparation for the manufacture of packaging and/or products described herein. In some embodiments, the dryer 806 may be configured to dry the constituent materials within a predetermined threshold (e.g., an amount, or percentage, of water content remaining in the constituent materials). Previously dried BSG (e.g., BSG having less than a predetermined amount of water content) may not require drying by the dryer 806 and, as such, the dryer 806 or any steps associated therewith may be bypassed.

The polymer additive station 810 may comprise a holding tank, or other container, for the dried constituent materials to be mixed with a predetermined amount of another ingredient comprising at least one of a polymer and/or other chemicals. Adding a polymer to the dried constituent materials may form a fiber-reinforced and/or formable material. Examples of polymers that can be added to the dried constituent materials at the polymer additive station 810 may include, but are in no way limited to, thermoplastics, acrylonitrile butadiene styrene (ABS), polyethylene terephthalate (PET), low-density polyethylene (LDPE), high-density polyethylene (HDPE), and/or the like. In some embodiments, the polymer may be selected based on an ability to later recycle the polymer separately from the other constituent materials of the finally formed and/or manufactured product (e.g., providing an eco-friendly, low-waste, product).

The filament forming station 814 may include a filament extruder and/or other system that processes the fiber-reinforced material received from the polymer additive station 810 and forms or extrudes a BSG filament therefrom. The BSG filament may comprise a continuous, or substantially continuous, threadlike fiber that may be wound on a core or other mandrel. In some embodiments, the BSG filament may be used in a 3D printer 818. The 3D printer 818 may comprise a fused deposition modeler, an additive manufacturing system, and/or some other filament-based rapid prototyping, printing, or manufacturing machine or system. Although the 3D printer 818 is capable of producing a product of any shape (or combination of shapes), at least one advantage of the 3D printer 818 includes the ability to manufacture complex 3D shapes. For instance, the 3D printer 818 may be used to manufacture one or more products using the BSG filament that have a 3D, or non-flat, shape.

In some embodiments, the BSG processing system 800 may include one or more packaging stations 822 that can package a product 820 and/or any portion of the processed BSG mixture for shipment and/or storage. For instance, the shredded and dried processed BSG mixture may be packaged in bins, boxes, or other containers to be shipped to a paper/cardboard manufacturer for further processing. The polymer-reinforced processed BSG mixture may be packaged and shipped to a molder or package manufacturer (e.g., in the form of sheets of material, rolls of material, etc.). And, the BSG filament may be packaged and shipped to a manufacturing facility that, for example, uses 3D printers to produce products, a textile manufacturer, or a consumer, etc. (e.g., in the form of spools of material, rolls of material, rods of material, etc.) The packaging station 822 may include an automated boxing system, a robotic handling system, and/or a shipping system.

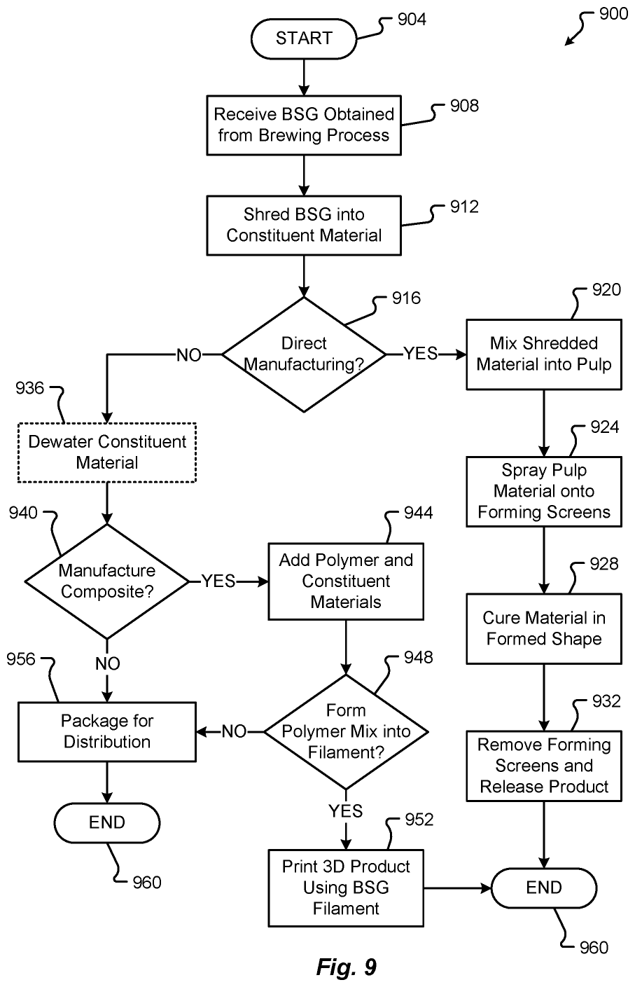

FIG. 9 is a flow diagram of a method 900 for processing constituent materials from BSG for making packaging and/or products. While a general order of the steps is shown, the method 900 can include more or fewer steps or can arrange the order of the steps differently than those shown in FIG. 9. In some embodiments, the method 900 may be performed in full, or in part, by a controller comprising a processor and a memory. For example, the controller may be a programmable logic controller (PLC) configured to perform any of the steps of the method 900 automatically and/or in one or more sequences. In one embodiment, the steps of the method 900 may be performed by a number of processors or controllers, associated with one or more of the subsystems, devices, units, and/or systems in the extraction system 100 and/or the BSG processing system 800.

The method 900 may begin at step 904 and proceed by receiving spent grains (e.g., BSG) obtained from a brewing process (step 908). In some embodiments, the BSG may comprise spent grains from a brewer hygienically controlled and stored. In one embodiment, the BSG may be stored in a hot grain storage system 108 as described in conjunction with FIG. 1. In any event, the BSG (e.g., comprising spent grains and/or spent husks, etc.) may be conveyed (e.g., via a conveyor belt, pipe, screw, or other material handling device, etc.) to a material shredder 804. As described above, the material shredder 804 may shred the BSG into a predetermined size of constituent material for use in manufacturing products such as packaging and/or packaging materials.

The method 900 may continue by determining whether the shredded material requires further processing to be used in manufacturing or is ready for direct manufacturing of products (step 916). If the shredded material is ready for direct manufacturing, the method 900 proceeds by mixing the shredded material into a predetermined pulp size and balance (step 920). The pulp size may be set to suit a particular type of product to be manufactured. For instance, mixing the pulp may include isolating longer fibers (e.g., through filtration, etc.) in the shredded material to form a strong paper-like product. Balancing the pulp mix may include determining a composition of the pulp material and ensuring the composition matches a defined percentage of grains, hops, and spice or flavor elements. For example, the defined composition of the constituent materials in the pulp may be a mixture of grains, hops, and spices. In one embodiment, the defined percentage, or balance, of the mixture may comprise 80% to 90% grains, 10% to 20% hops, and a trace amount (e.g., less than 1%) of spices by weight. In yet another embodiment, the defined percentage, or balance, of the mixture may comprise approximately 84.6% malt and wheat (e.g., grains), 14.9% hops, and 0.5% spice and flavoring.

Next, the pulp may be sprayed onto forming screens (e.g., mesh screens) (step 924). As provided above, the mesh screens (e.g., of the forming station 812, etc.) may allow small fibers, chemicals, and/or water to pass through the forming screens while retaining long fibers in a layer deposited thereon.

The material disposed on the forming screens may be heat, pressure, and/or time cured to form an initial or base shape of the product (step 928). In some embodiments, the material may be pressed or compressed at this step to, among other things, remove water content (e.g., dry) and/or form the initial shape of the product. One or more heating elements (e.g., heaters, fans, etc., and/or combinations thereof) may be used to dry and cure the material on the forming screens. In some embodiments, the heating elements may dry and cure the material in the shape of the product, while the material is under pressure (e.g., being pressed or compressed, etc.). The cured material may be harder than the material prior curing and may be capable of retaining the shape of the product.

Once cured, the method 900 may continue by removing the material from the forming screens (step 932). In some cases, removing the material may include passing a blade across, or offset from, a surface of the forming screen to separate at least a majority of the material from the forming screen. In one embodiment, the material may be inverted from a first forming position to a release position to separate the material from the forming screens. A portion of material may remain on the forming screens. This remaining material may be recycled and/or cleaned from the forming screens. In one embodiment, recycling the remaining material may comprise returning the remaining material to the material shredder 804 and/or the pulp mix station 808 to be reprocessed. In some embodiments, the formed material may retain the shape of the product when removed from the forming screens or other mold.

In some embodiments, removing the material from the forming screens may include preparing the removed material for further treatment, for packaging/shipping, and/or for storage. For instance, the removed material may be collected onto a roll, cut into a shape, trimmed, etc., and/or combinations thereof. Collecting the processed material onto rolls may allow for easy transport, for use in a converting machine, and/or compact storage. In any event, the method 900 may end at step 960.

If the shredded material is not ready for direct manufacturing, and may require additional processing before manufacturing into a product, the method 900 may proceed from step 916 by optionally dewatering (e.g., drying) the constituent material (step 936). In some embodiments, the BSG or the constituent material may have an amount of water content higher than a predetermined threshold for manufacturing and, as such, may need to be removed. The constituent material may be dewatered using the dryer 806 described in conjunction with the BSG processing system 800 of FIG. 8. As provided above, previously dried BSG may be obtained in step 908, in which case, the dewatering step (936) may be bypassed.

From this point, the method 900 may continue by preparing the material for distribution (e.g., shipping to a manufacturer of products and/or packaging, etc.)(step 956) or by further processing the material by adding a polymer to the constituent materials (step 944). In some embodiments, a polymer may be added to the constituent materials to produce a fiber-reinforced polymer, a formable product, and/or enhance the capabilities (e.g., product life, plasticity, strength, etc.) associated with the processed BSG material. In some embodiments, the polymers added (e.g., via the polymer additive station 810, etc.) may include, but are in no way limited to, thermoplastics, acrylonitrile butadiene styrene (ABS), polyethylene terephthalate (PET), low-density polyethylene (LDPE), high-density polyethylene (HDPE), and/or the like. In some embodiments, the polymer may be selected based on an ability to later recycle the polymer separately from the other constituent materials of the finally formed and/or manufactured product. The polymer may be mixed together with the constituent materials until a BSG composite material is formed. Adding the polymer may include producing a thermosetting matrix with the fibers in the constituent material of the BSG.

In one embodiment, the method 900 may continue by producing a BSG polymer filament from the BSG composite material formed in step 944 (step 948). The filament may be formed by a filament extruder and/or other system that processes the BSG composite material received from the polymer additive station 810 and forms or extrudes a BSG filament therefrom. The BSG filament may comprise a continuous, or substantially continuous, threadlike fiber that can be wound on a core or other mandrel. Once wound, the BSG filament may form a spool of fiber that can be used in subsequent manufacturing processes (e.g., 3D printing, weaving, textile manufacturing, etc.). The BSG filament may be made by the filament forming station 814 described in conjunction with the BSG processing system 800 of FIG. 8.

In some embodiments, the method 900 may proceed by using the BSG filament to “print” a product or package (step 952). For instance, the BSG filament may be used in a 3D printer 818 such as a fused deposition modeler, an additive manufacturing system, and/or another filament-based rapid prototyping, printing, or manufacturing system. The 3D printer 818 may be used to manufacture one or more products using the BSG filament that include a 3D, or non-flat, shape or geometry. Examples of packaging products produced by the 3D printer may include, but are in no way limited to, beverage can rings, boxes, dividers, coasters, carriers, etc.

Any of the BSG products (e.g., the shredded constituent materials, the BSG composite material, the BSG filament, and/or the product 820, or constituent materials used in the process 900 may be packaged for distribution (step 956), or other use, as described at least in conjunction with the description of the packaging station 822 described in conjunction with FIG. 8.

Any of the steps, functions, and operations discussed herein can be performed continuously and automatically.

The exemplary systems and methods of this disclosure have been described in relation to processing constituent materials obtained from BSG and/or spent grains in making products and/or packaging. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a method of processing spent grains, comprising: receiving, from a storage unit, spent grains; arranging the spent grains into a set of balanced constituent materials comprising substantially 80% to 90% grains, 10% to 20% hops, and less than 1% of spices by weight; and producing a product with the set of balanced constituent materials.

Aspects of the above method include wherein the set of balanced constituent materials are combined into a unified manufacturing material. Aspects of the above method include wherein the product is made from the unified manufacturing material. Aspects of the above method include wherein arranging the spent grains into the set of balanced constituent materials, further comprises: shredding the spent grains into a predetermined size; and mixing the shredded spent grains with water into a pulp. Aspects of the above method further comprise spraying the pulp onto a forming screen, wherein the forming screen allows water to pass therethrough while maintaining a layer of the pulp on a surface thereof; curing the pulp on the forming screen; and releasing the product from the forming screen. Aspects of the above method include wherein the product is a paper-like product and is collected on a roll. Aspects of the above method include wherein the grains of the set of balanced constituent materials comprise malt and wheat, and wherein the set of balanced constituent materials comprise approximately 85% of the spent grains by weight. Aspects of the above method include wherein the hops of the set of balanced constituent materials comprise approximately 15% of the spent grains by weight.

Embodiments include a method for producing a manufacturing material from brewer's spent grains, comprising: receiving brewer's spent grains comprising spent grain husks and sprouts; shredding the received brewer's spent grains into a shredded material comprising a predetermined shred size; mixing the shredded material in a container with water and at least one chemical forming a pulp; depositing the pulp onto a shaped forming screen; and removing water content from the pulp on the shaped forming screen forming the manufacturing material.

Aspects of the above method include wherein removing the water content from the pulp further comprises heat curing the pulp while on the shaped forming screen. Aspects of the above method include wherein removing the water content from the pulp further comprises compressing the pulp on the shaped forming screen while the pulp is heat cured into a product shape matching a shape of the shaped forming screen. Aspects of the above method include wherein mixing the shredded material in the container further comprises filtering the shredded material to isolate a range of predetermined fiber lengths remaining in the shredded material. Aspects of the above method include wherein the brewer's spent grains are balanced to comprise a mixture of 80% to 90% grains, 10% to 20% hops, and less than 1% of spices by weight. Aspects of the above method include wherein the manufacturing material is shaped into a bottle label comprising a visible surface and an adhesive receiving surface disposed opposite the visible surface, and wherein the visible surface comprises at least one metallized layer deposited thereon. Aspects of the above method include wherein depositing the pulp onto a shaped forming screen comprises spraying the pulp onto a mesh of the shaped forming screen, wherein the mesh allows water to pass therethrough while maintaining a layer of the pulp on a surface of the shaped forming screen.

Embodiments include a product made from brewer's spent grains, comprising: a mixture obtained from the brewer's spent grains, the mixture comprising 80% to 90% grains, 10% to 20% hops, and less than 1% of spices by weight of the product, wherein the mixture is shredded to a predetermined shred size and is combined together with at least one ingredient forming a manufacturing material of the product, and wherein the manufacturing material is formed into a shape of the product.

Aspects of the above product include wherein the manufacturing material is formed by molding the shape of the product with a mold, and wherein the manufacturing material is heat cured and hardened such that the product retains the shape of the product after removal from the mold. Aspects of the above product include wherein the shape of the product is a flattened sheet of material manufacturing material that is rolled onto a core. Aspects of the above product include wherein the at least one ingredient comprises a polymer that is at least one of acrylonitrile butadiene styrene (ABS), polyethylene terephthalate (PET), low-density polyethylene (LDPE), and/or high-density polyethylene (HDPE). Aspects of the above product include wherein the manufacturing material is formed into the shape of the product by extruding the product as a fiber-reinforced filament, and wherein the fiber-reinforced filament is wound onto a spool. Aspects of the above product include wherein the product is a label, and wherein the label further comprises: a visible surface; and an adhesive surface disposed opposite the visible surface. Aspects of the above product include wherein the visible surface comprises at least one metallized layer deposited thereon.

Any one or more of the aspects/embodiments as substantially disclosed herein.

Any one or more of the aspects/embodiments as substantially disclosed herein optionally in combination with any one or more other aspects/embodiments as substantially disclosed herein.

One or more means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

What is claimed is:

1. A method of processing spent grains, comprising:
receiving, from a storage unit, spent grains;
arranging the spent grains into a set of balanced constituent materials comprising substantially 80% to 90% grains, 10% to 20% hops, and less than 1% of spices by weight; and
producing a product with the set of balanced constituent materials.

2. The method of claim 1, wherein arranging the spent grains into the set of balanced constituent materials, further comprises:
shredding the spent grains into a predetermined size; and
mixing the shredded spent grains with water into a pulp.

3. The method of claim 2, further comprising:
spraying the pulp onto a forming screen, wherein the forming screen allows water to pass therethrough while maintaining a layer of the pulp on a surface thereof;
curing the pulp on the forming screen; and
releasing the product from the forming screen.

4. The method of claim 3, wherein the product is a paper-like product and is collected on a roll.

5. The method of claim 3, wherein the grains of the set of balanced constituent materials comprise malt and wheat, and wherein the set of balanced constituent materials comprise approximately 85% of the spent grains by weight.

6. The method of claim 5, wherein the hops of the set of balanced constituent materials comprise approximately 15% of the spent grains by weight.

7. A method for producing a manufacturing material from brewer's spent grains, comprising:
receiving brewer's spent grains comprising spent grain husks and sprouts;
shredding the received brewer's spent grains into a shredded material comprising a predetermined shred size;
mixing the shredded material in a container with water and at least one chemical forming a pulp;
depositing the pulp onto a shaped forming screen; and
removing water content from the pulp on the shaped forming screen forming the manufacturing material.

8. The method of claim 7, wherein removing the water content from the pulp further comprises heat curing the pulp while on the shaped forming screen.

9. The method of claim 8, wherein removing the water content from the pulp further comprises compressing the pulp on the shaped forming screen while the pulp is heat cured into a product shape matching a shape of the shaped forming screen.

10. The method of claim 8, wherein mixing the shredded material in the container further comprises filtering the shredded material to isolate a range of predetermined fiber lengths remaining in the shredded material.

11. The method of claim 10, wherein the brewer's spent grains are balanced to comprise a mixture of 80% to 90% grains, 10% to 20% hops, and less than 1% of spices by weight.

12. The method of claim 11, wherein the manufacturing material is shaped into a bottle label comprising a visible surface and an adhesive receiving surface disposed opposite the visible surface, and wherein the visible surface comprises at least one metallized layer deposited thereon.

13. The method of claim 11, wherein depositing the pulp onto a shaped forming screen comprises spraying the pulp onto a mesh of the shaped forming screen, wherein the mesh allows water to pass therethrough while maintaining a layer of the pulp on a surface of the shaped forming screen.

14. A product made from brewer's spent grains, comprising:
a mixture obtained from the brewer's spent grains, the mixture comprising 80% to 90% grains, 10% to 20% hops, and less than 1% of spices by weight of the product, wherein the mixture is shredded to a predetermined shred size and is combined together with at least one ingredient forming a manufacturing material of the product, and wherein the manufacturing material is formed into a shape of the product.

15. The product of claim 14, wherein the manufacturing material is formed by molding the shape of the product with a mold, and wherein the manufacturing material is heat cured and hardened such that the product retains the shape of the product after removal from the mold.

16. The product of claim 14, wherein the shape of the product is a flattened sheet of material manufacturing material that is rolled onto a core.

17. The product of claim 14, wherein the at least one ingredient comprises a polymer that is at least one of acrylonitrile butadiene styrene (ABS), polyethylene terephthalate (PET), low-density polyethylene (LDPE), and/or high-density polyethylene (HDPE).

18. The product of claim 17, wherein the manufacturing material is formed into the shape of the product by extruding the product as a fiber-reinforced filament, and wherein the fiber-reinforced filament is wound onto a spool.

19. The product of claim 14, wherein the product is a label, and wherein the label further comprises:
a visible surface; and
an adhesive surface disposed opposite the visible surface.

20. The product of claim 19, wherein the visible surface comprises at least one metallized layer deposited thereon.
